(19) United States
(12) Patent Application Publication
(10) Pub. No.: US 2003/0077212 A1
(43) Pub. Date: Apr. 24, 2003

(54) Method and device for exhaust gas purification

(76) Inventor: Thomas Hammer, Hemhofen (DE)

Correspondence Address: LERNER AND GREENBERG, P.A., PATENT ATTORNEYS AND ATTORNEYS AT LAW, Post Office Box 2480, Hollywood, FL, 33020-2480, US

(21) Appl. No.: 10/287,504

(22) Filed: Nov. 4, 2002

Related U.S. Application Data
(63) Continuation of application No. PCT/DE01/01686, filed on May 3, 2001.

(30) Foreign Application Priority Data
May 4, 2000 (DE) 100 21 693.5

(51) Int. Cl. B01D 53/56; B01D 53/34

(52) U.S. Cl. 423/239.1; 423/235; 422/168

(57) ABSTRACT

Diesel engines and/or lean-burn internal combustion engines require a so-called SCR catalyst for the selective catalytic reduction of nitrogen oxides to purify their exhaust gases, which can be additionally activated by non-thermal gas-discharge plasmas. The invention includes absorbing the hydrocarbons contained in the exhaust gases to a large extent, and then feeding the exhaust gases to the non-thermal gas-discharge plasma. An ammonia-based reducing agent is added to the exhaust gases so treated and the exhaust gases are supplied to the SCR catalyst to reduce the nitrogen oxides. The corresponding device includes a hydrocarbon absorber, a gas-discharge reactor, a dosing unit for a reducing agent, and an SCR catalyst connected in series in the exhaust gas train close to the engine.

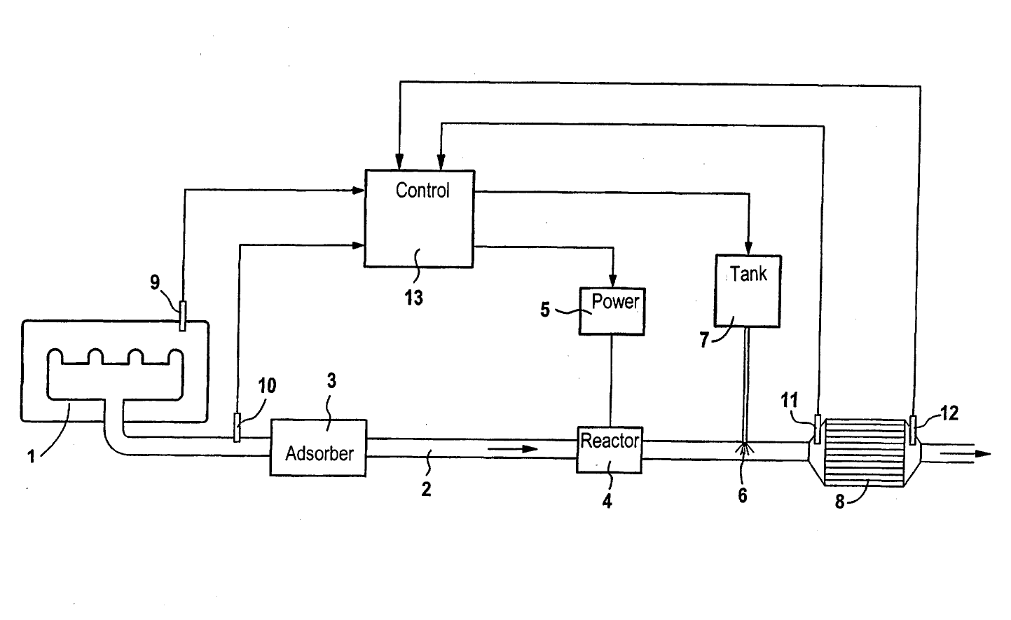

### CROSS-REFERENCE TO RELATED APPLICATION

This application is a continuation of copending International Application No. PCT/DE01/01686, filed May 3, 2001, which designated the United States and was not published in English.

### BACKGROUND OF THE INVENTION

1. Field of the Invention

The invention relates to a method for exhaust gas purification, in particular, for the purification of exhaust gases from diesel engines and/or spark-ignition lean-burn engines, using a selective catalytic reduction (SCR) catalytic converter for the selective catalytic reduction of nitrogen oxides, with the exhaust gases being activated by non-thermal gas discharge plasmas. In addition, the invention also relates to the associated device with measures for carrying out the described process.

The selective catalytic reduction of nitrogen oxides in diesel and lean-burn engine exhaust gas using monolithic V₂O₅—WO₃/TiO₂ catalytic converters and using ammonia-based reducing agents, such as urea, at catalytic converter temperatures above 200° C. is an effective method for purifying the exhaust gases from motor vehicles, in particular, trucks. Such a method not only reduces the emissions of nitrogen oxides, but also reduces the emissions of hydrocarbons given a suitably selected catalyst composition.

On the other hand, at catalytic converter temperatures below 200° C., which often occur in automobiles in urban traffic, it is impossible to achieve sufficient reduction of nitrogen oxides without using additional measures. To solve such a problem, in International publication WO 98/52679 A1, corresponding to U.S. Pat. No. 6,247,303 to Broeer et al., it is proposed for a non-thermal gas discharge plasma to be connected upstream of the SCR catalytic converter. In extensive tests carried out with such a configuration including plasma reactor and SCR catalytic converter, it was possible to successfully demonstrate effective reduction of NOₓ at temperatures as low as less than 100° C. However, it was found that when there is a high concentration of hydrocarbons in the exhaust gas, as occurs during a cold start and on short distances, the degree of NOₓ reduction drops dramatically. Such a drop is evidently associated with the properties of the catalytic converter, which are required to effectively lower the emissions of the hydrocarbons.

By using heating catalytic converters, it was possible to reduce the emission of the nitrogen oxides in urban traffic by rapidly reaching the operating temperature for selective catalytic reduction. However, the rapid reaching of the operating temperature requires the use of catalytic converters with metallic supports, which have serious drawbacks for the urea SCR process, such as a low ammonia storage capacity and high costs compared to monolithic catalytic converters. In addition, there is the electric power consumption of typically 3 kW, which cannot be ignored.

### SUMMARY OF THE INVENTION

It is accordingly an object of the invention to provide a method and device for exhaust gas purification that overcome the hereinafore-mentioned disadvantages of the heretofore-known devices and methods of this general type and that, at low catalytic converter temperatures, reduce the emissions of nitrogen oxides and also prevent the emission of hydrocarbons in high concentrations regardless of the hydrocarbon content of the exhaust gas.

With the foregoing and other objects in view, there is provided, in accordance with the invention, a method for purification of exhaust gas utilizing an SCR catalytic converter for the selective catalytic reduction of nitrogen oxides, including the steps of first adsorbing hydrocarbons present in the exhaust gas to an extent that does not impair an ability of the SCR catalytic converter to take up a reducing agent at low exhaust gas temperatures, activating the exhaust gas with a non-thermal gas discharge plasma by subsequently exposing the exhaust gas to the non-thermal gas discharge plasma to oxidize some of the NO present in the nitrogen oxides to form NO₂, subsequently adding a reducing agent based on ammonia to the exhaust gas so pretreated, and feeding the exhaust gas to the SCR catalytic converter for reduction of the nitrogen oxides. Preferably, the hydrocarbons present in the exhaust gas are adsorbed to an extent that does not impair an ability of the SCR catalytic converter to take up a reducing agent at exhaust-gas temperatures below 200° C. In a preferred embodiment, the method purifies exhaust gas from diesel engines and/or lean-burn engines.

In the invention, in a first step, the hydrocarbons present in the exhaust gas are adsorbed. In a second step, the exhaust gas, which now has low hydrocarbon content, is exposed to non-thermal gas discharge plasma to oxidize some of the NO to form NO₂. In a third step, a reducing agent based on ammonia is added to the exhaust gas. In a final step, the exhaust gas is fed to the SCR catalytic converter for reduction of the nitrogen oxides. For such a purpose, the associated device has a first hydrocarbon adsorber, which is accommodated close to the engine in the exhaust section, a reactor for generating non-thermal gas discharge plasmas, a metering unit for a reducing agent, and an SCR catalytic converter.

In the invention, the hydrocarbon adsorber may advantageously be configured such that the hydrocarbons are desorbed at temperatures at which the SCR catalytic converter oxidizes hydrocarbons.

In accordance with another mode of the invention, the hydrocarbon adsorber is selected such that, at relatively high exhaust-gas temperatures, in addition to the adsorption, catalytic oxidization of the hydrocarbons takes place to form carbon dioxide and water. The sequence of the method is, then, preferably, oxidation of the hydrocarbons, plasma-induced oxidation of the NO to form NO₂, addition of the reducing agent, and selective catalytic reduction of the NOₓ.

In accordance with a further mode of the invention, the hydrocarbon adsorber used, at relatively high exhaust-gas temperatures, oxidizes hydrocarbons to form carbon dioxide and water, and, at the same time, oxidizes some of the NO to form NO₂. The sequence of the method, then, includes the catalytic oxidation of the hydrocarbons and some of the NO, the addition of the reducing agent and the selective catalytic reduction of the NOₓ.

In accordance with an added mode of the invention, an electrical output of the plasma treatment and the addition of the reducing agent are controlled dependent upon a composition of the exhaust gas and temperatures of the exhaust gas at the hydrocarbon adsorber and at the SCR catalytic converter.

With the objects of the invention in view, there is also provided an exhaust gas purifying system for an engine having an exhaust section, including an SCR catalytic converter for reducing nitrogen oxides in the exhaust gas, a reducing agent metering unit dispensing a reducing agent based on ammonia, a hydrocarbon adsorber adsorbing hydrocarbons present in the exhaust gas to an extent that does not impair an ability of the SCR catalytic converter to take up the reducing agent at low exhaust gas temperatures, the hydrocarbon adsorber disposed in a vicinity of the engine in the exhaust section, a reactor generating a non-thermal gas discharge plasma, the reactor disposed in the exhaust section and activating the exhaust gas by exposing the exhaust gas exiting from the adsorber to the non-thermal gas discharge plasma to oxidize some of the NO present in the nitrogen oxides of the exhaust gas to form NO₂, the metering unit dispensing the reducing agent to the exhaust section downstream of the reactor with respect to a flow direction of the exhaust gas, and the SCR catalytic converter disposed in the exhaust section downstream of the metering unit with respect to the flow direction of the exhaust gas.

In accordance with an additional feature of the invention, the hydrocarbon adsorber has an adsorber material with a given pore volume, a given pore diameter, and catalytic properties.

In accordance with yet another feature of the invention, the material contains zeolites, in particular, NH₄ZSM5 and/or NaZSM5.

In accordance with yet a further feature of the invention, the material is selected from at least one of the group consisting of platinum-doped Pt—NH₄ZSM5 and copper-doped Cu—NaZSM5.

In accordance with yet an added feature of the invention the material is a platinum-doped γ-aluminum oxide.

In accordance with yet an additional feature of the invention, the material has a support material selected from Al₂O₃ ceramic or cordierite.

In accordance with again another feature of the invention, the SCR catalytic converter has an adsorber material of an unsupported V₂O₅—WO₃/TiO₂ extrudate.

In accordance with again a further feature of the invention, the V₂O₅—WO₃/TiO₂ catalytic converter has amounts of added Pt to promote hydrocarbon oxidation.

In accordance with again an added feature of the invention, the adsorber material is an adsorber material in the SCR catalytic converter of an unsupported V₂O₅—WO₃/TiO₂ extrudate.

In accordance with again an additional feature of the invention, the V₂O₅—WO₃/TiO₂ catalytic converter has amounts of added Pt to promote hydrocarbon oxidation.

In accordance with still another feature of the invention, there are provided sensors, a first of the sensors recording operating states of the engine, a second of the sensors recording properties of the exhaust gas, and at least a third of the sensors recording properties of the catalytic converter.

In accordance with still a further feature of the invention, the second sensor records at least one of a temperature of the exhaust gas and a composition of the exhaust gas.

In accordance with still an added feature of the invention, the sensors produce signals and a unit is connected to the sensors and the reactor, evaluates the signals, and controls the reactor and the metering device as a function of values measured with the sensors and transmitted through the signals.

With the objects of the invention in view, there is also provided a exhaust gas purifying system for the purification of exhaust gases from at least one of diesel engines and lean-burn engines having an exhaust section, including an SCR catalytic converter for reducing nitrogen oxides in the exhaust gas, a reducing agent metering unit dispensing a reducing agent based on ammonia, a hydrocarbon adsorber adsorbing hydrocarbons present in the exhaust gas to an extent that does not impair an ability of the SCR catalytic converter to take up the reducing agent at low exhaust gas temperatures, the hydrocarbon adsorber disposed in a vicinity of the engine in the exhaust section, a reactor generating a non-thermal gas discharge plasma, the reactor disposed in the exhaust section and activating the exhaust gas by exposing the exhaust gas exiting from the adsorber to the non-thermal gas discharge plasma to oxidize some of the NO present in the nitrogen oxides of the exhaust gas to form NO₂, the metering unit dispensing the reducing agent to the exhaust section downstream of the reactor with respect to a flow direction of the exhaust gas, and the SCR catalytic converter disposed in the exhaust section downstream of the metering unit with respect to the flow direction of the exhaust gas.

Further details and advantages of the invention will emerge from the following description of an exemplary embodiment based upon the drawing. The only FIGURE shows the structure of an exhaust gas purification system for plasma-enhanced selective catalytic reduction.

Selective catalytic reduction (SCR) of nitrogen oxides in exhaust gases from diesel and spark-ignition lean-burn engines exist in the prior art. SCR catalytic converters that are suitable for such a purpose, for example, monolithic V₂O₅—WO₃/TiO₂ catalytic converters, are proposed in the literature. Such SCR catalytic converters effectively reduce the undesirable nitrogen oxides. However, they are sensitive to hydrocarbons, which are adsorbed.

The adsorption of hydrocarbon on an existing SCR catalytic converter is to be prevented because, otherwise, its efficiency is limited. In such a context, the following assumptions or knowledge are used as a basis:

1. Adsorption of hydrocarbons on the surface of the SCR catalytic converter reduces the ability of the catalytic converter to adsorb the reducing agent; and

2. The adsorbed hydrocarbons reduce the NO₂ that is produced from NO in the non-thermal gas discharge plasma so that it, again, forms NO.

Both effects occur primarily at temperatures below 200° C. and, thereby, reduce the rate of the plasma-enhanced selective catalytic reduction. However, both effects are eliminated if the adsorption of hydrocarbons on the SCR catalytic converter is avoided, for which purpose a specific sequence of the individual method steps is made possible by a novel configuration.

Other features that are considered as characteristic for the invention are set forth in the appended claims.

Although the invention is illustrated and described herein as embodied in a method and device for exhaust gas purification, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawing.

### BRIEF DESCRIPTION OF THE DRAWINGS

The FIGURE is a block circuit diagram of an exhaust gas purification system according to the invention for plasma-enhanced selective catalytic reduction in a motor vehicle.

### DESCRIPTION OF THE PREFERRED EMBODIMENTS

Referring now to the single FIGURE of the drawing, it is seen that an internal combustion engine 1 with an exhaust section 2 has a first hydrocarbon adsorber 3, which is accommodated close to the engine in the exhaust section 2, a reactor 4 for generating non-thermal gas discharge plasmas, the reactor 4 being associated with an electrical power supply unit 5, a metering unit 6 for a reducing agent RM stored in a tank 7, and an SCR catalytic converter 8. There are also sensors 9 to 12 for recording operating states of the engine 1, for recording exhaust-gas properties, such as temperature and/or exhaust-gas composition, and for recording catalytic converter properties, which are evaluated in a unit 13. There is a common control unit 13 for the plasma reactor 4 and the SCR system 8.

The hydrocarbon adsorber 3 selected is, advantageously, a material with a large pore volume and large pore diameter that has catalytic properties; suitable materials are zeolites, such as NH₄ZSM5 or NaZSM5, the properties of which can be matched to the particular application by metallic doping. On account of low response temperatures for the catalytic oxidation of the hydrocarbons, platinum-doped Pt—NH₄ZSM5 and copper-doped Cu—NaZSM5 are particularly suitable. γ-aluminum oxide, which may, likewise, be doped with Pt, is also suitable. These materials may be applied to Al₂O₃ ceramic or to cordierite as support material.

Finally, it is also possible for the material of the SCR catalytic converter 8, itself—i.e., typically a V₂O₅—WO₃/TiO₂ catalyst—to be used for the hydrocarbon adsorber 3, and, in such a case, too, the material may be applied to a support. However, on account of the larger pore volume, preference is given to an unsupported extrudate, which can be produced with the addition of fiber materials and a binder. Such a process is described in detail in “Hydrocarbon Sorption and Oxidation Catalyst for Heavy Duty Engines”, SAE Technical Paper Series, Paper No. 1999-01-3560 (1999). To promote the oxidation of the hydrocarbons to form CO₂ and to prevent hydrocarbons that have already been adsorbed from being released again as the temperature rises, it is possible to add up to a few tenths of a percent of a precious metal, such as Pt or Pd, as oxidation catalyst. By optimally adapting the components to one another, specifically, by selecting the V₂O₅ content of the adsorber 3, it is possible to dramatically lower the concentration of hydrocarbons in the exhaust gas over the temperature range from 50° C. to 500° C.

In the configuration illustrated in the FIGURE of the drawing, the hydrocarbons are adsorbed at the adsorber 3 to such an extent that at low exhaust-gas temperature they have no adverse effect on the ability of the SCR catalytic converter 8 to take up the reducing agent RM. The exhaust gas that has been so pretreated is exposed to the non-thermal gas discharge plasma in the reactor 4 to oxidize some of the NO that is present in the nitrogen oxides to form NO₂. Then, ammonia-based reducing agent RM is added to this pretreated exhaust gas through the metering unit 6. Then, the exhaust gas, including the reducing agent RM, is fed to the SCR catalytic converter 8 for reduction.

The method just described results in a considerable improvement in lowering the emissions in exhaust gases from diesel and spark-ignition lean-burn engines. In the novel method, when the temperature is sufficiently high, the hydrocarbons can be catalytically oxidized to form carbon dioxide and water. Particularly, at relatively high exhaust-gas temperatures, some of the NO that is present in the nitrogen oxides is catalytically oxidized to form NO₂. Suitable control of the electrical power of the reactor 4 for generating the non-thermal plasmas and of the metering of the reducing agent RM as a function of the exhaust-gas composition measured by the sensors and of the exhaust-gas temperatures at the hydrocarbon adsorber 3 and at the SCR catalytic converter 8 allows operation of the exhaust-gas purification system to be optimized.

I claim:

1. A method for purification of exhaust gas utilizing an SCR catalytic converter for the selective catalytic reduction of nitrogen oxides, which comprises:
first adsorbing hydrocarbons present in the exhaust gas to an extent that does not impair an ability of the SCR catalytic converter to take up a reducing agent at low exhaust gas temperatures;
activating the exhaust gas with a non-thermal gas discharge plasma by subsequently exposing the exhaust gas to the non-thermal gas discharge plasma to oxidize some of the NO present in the nitrogen oxides to form NO₂;
subsequently adding a reducing agent based on ammonia to the exhaust gas so pretreated; and
feeding the exhaust gas to the SCR catalytic converter for reduction of the nitrogen oxides.

2. The method according to claim 1, wherein the adsorbing step further comprises additionally carrying out a catalytic oxidation of hydrocarbons at a temperature sufficient to form carbon dioxide and water.

3. The method according to claim 2, wherein, at a sufficiently high exhaust gas temperature, some of the NO present in the nitrogen oxides is catalytically oxidized to form NO₂.

4. The method according to claim 2, wherein, above a given high exhaust gas temperature, some of the NO present in the nitrogen oxides is catalytically oxidized to form NO₂.

5. The method according to claim 1, which further comprises controlling an electrical output of the plasma treatment and the addition of the reducing agent dependent upon a composition of the exhaust gas and temperatures of the exhaust gas at the hydrocarbon adsorber and at the SCR catalytic converter.

6. A method for purification of exhaust gas utilizing an SCR catalytic converter for the selective catalytic reduction of nitrogen oxides, which comprises:
first adsorbing hydrocarbons present in the exhaust gas to an extent that does not impair an ability of the SCR catalytic converter to take up a reducing agent at exhaust-gas temperatures below 200° C.;
activating the exhaust gas with a non-thermal gas discharge plasma by subsequently exposing the exhaust gas to the non-thermal gas discharge plasma to oxidize some of the NO present in the nitrogen oxides to form NO₂;
subsequently adding a reducing agent based on ammonia to the exhaust gas so pretreated; and
feeding the exhaust gas to the SCR catalytic converter for reduction of the nitrogen oxides.

7. A method for purification of exhaust gas from at least one of diesel engines and lean-burn engines, utilizing an SCR catalytic converter for the selective catalytic reduction of nitrogen oxides, which comprises:
first adsorbing hydrocarbons present in the exhaust gas to an extent that does not impair an ability of the SCR catalytic converter to take up a reducing agent at low exhaust-gas temperatures;
activating the exhaust gas with a non-thermal gas discharge plasma by subsequently exposing the exhaust gas to the non-thermal gas discharge plasma to oxidize some of the NO present in the nitrogen oxides to form NO₂;
subsequently adding a reducing agent based on ammonia to the exhaust gas so pretreated; and
feeding the exhaust gas to the SCR catalytic converter for reduction of the nitrogen oxides.

8. An exhaust gas purifying system for an engine having an exhaust section, comprising:
an SCR catalytic converter for reducing nitrogen oxides in the exhaust gas;
a reducing agent metering unit dispensing a reducing agent based on ammonia;
a hydrocarbon adsorber adsorbing hydrocarbons present in the exhaust gas to an extent that does not impair an ability of said SCR catalytic converter to take up said reducing agent at low exhaust gas temperatures, said hydrocarbon adsorber disposed in a vicinity of the engine in the exhaust section;
a reactor generating a non-thermal gas discharge plasma, said reactor disposed in the exhaust section and activating the exhaust gas by exposing the exhaust gas exiting from said adsorber to said non-thermal gas discharge plasma to oxidize some of the NO present in the nitrogen oxides of the exhaust gas to form NO₂;
said metering unit dispensing said reducing agent to the exhaust section downstream of said reactor with respect to a flow direction of the exhaust gas; and
said SCR catalytic converter disposed in the exhaust section downstream of said metering unit with respect to the flow direction of the exhaust gas.

9. The device according to claim 8, wherein said hydrocarbon adsorber has an adsorber material with a given pore volume, a given pore diameter, and catalytic properties.

10. The device according to claim 9, wherein said material contains zeolites.

11. The device according to claim 9, wherein said zeolites are selected from at least one of the group consisting of NH₄ZSM5 and NaZSM5.

12. The device according to claim 11, wherein said material is selected from at least one of the group consisting of platinum-doped Pt—NH₄ZSM5 and copper-doped Cu—NaZSM5.

13. The device according to claim 11, wherein said material is a platinum-doped γ-aluminum oxide.

14. The device according to claim 9, wherein said material has a support material selected from one of the group consisting of Al₂O₃ ceramic and cordierite.

15. The device according to claim 9, wherein said SCR catalytic converter has an adsorber material of an unsupported V₂O₅—WO₃/TiO₂ extrudate.

16. The device according to claim 15, wherein said V₂O₅—WO₃/TiO₂ catalytic converter has amounts of added Pt to promote hydrocarbon oxidation.

17. The device according to claim 9, wherein said adsorber material is an adsorber material in said SCR catalytic converter of an unsupported V₂O₅—WO₃/TiO₂ extrudate.

18. The device according to claim 15, wherein said V₂O₅—WO₃/TiO₂ catalytic converter has amounts of added Pt to promote hydrocarbon oxidation.

19. The device according to claim 8, including sensors, a first of said sensors recording operating states of the engine, a second of said sensors recording properties of the exhaust gas, and at least a third of said sensors recording properties of said catalytic converter.

20. The device according to claim 19, wherein said second sensor records at least one of a temperature of the exhaust gas and a composition of the exhaust gas.

21. The device according to claim 19, wherein:
said sensors produce signals; and
a unit:
is connected to said sensors and said reactor;
evaluates said signals; and
controls said reactor and said metering device as a function of values measured with said sensors and transmitted through said signals.

22. An exhaust gas purifying system for the purification of exhaust gases from at least one of diesel engines and lean-burn engines having an exhaust section, comprising:
an SCR catalytic converter for reducing nitrogen oxides in the exhaust gas;
a reducing agent metering unit dispensing a reducing agent based on ammonia;
a hydrocarbon adsorber adsorbing hydrocarbons present in the exhaust gas to an extent that does not impair an ability of said SCR catalytic converter to take up said reducing agent at low exhaust gas temperatures, said hydrocarbon adsorber disposed in a vicinity of the engine in the exhaust section;
a reactor generating a non-thermal gas discharge plasma, said reactor disposed in the exhaust section and activating the exhaust gas by exposing the exhaust gas exiting from said adsorber to said non-thermal gas discharge plasma to oxidize some of the NO present in the nitrogen oxides of the exhaust gas to form NO₂;
said metering unit dispensing said reducing agent to the exhaust section downstream of said reactor with respect to a flow direction of the exhaust gas; and
said SCR catalytic converter disposed in the exhaust section downstream of said metering unit with respect to the flow direction of the exhaust gas.
